(19) United States
(12) Patent Application Publication
(10) Pub. No.: US 2008/0154743 A1
(43) Pub. Date: Jun. 26, 2008

(54) METHOD CONCERNING THE TRANSPORT OF DENTAL PROSTHESES

(76) Inventors: Stephan Holzner, Hohenschaftlarn (DE); Gerhard Weber, Purgen (DE)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/954,339

(22) Filed: Dec. 12, 2007

(30) Foreign Application Priority Data
Dec. 22, 2006 (DE) 10 2006 061134.9

(51) Int. Cl. G06Q 30/00; A61C 13/08

(52) U.S. Cl. 705/26; 29/896.1

(57) ABSTRACT

The invention relates to a method, a machine-readable data carrier as well as a computer for commonly transmitting or receiving or dispatching data for dental prostheses and for product orders as well as dental prostheses or products.

### CROSS REFERENCE TO RELATED APPLICATION

This application claims priority under 35 U.S.C. §119 to German Patent Application No. 10 2006 061134.9 filed Dec. 22, 2006, the entire contents of which are incorporated herein by reference.

### FIELD OF THE INVENTION

The invention relates to methods concerning the transport of dental prostheses.

### BACKGROUND OF THE INVENTION

It is well-known that a dentistry laboratory or a dental surgery send a model data record for the manufacture of a dental prosthesis to a dental prosthesis manufacturing center, the latter manufactures the dental prosthesis and dispatches the same to the dentistry laboratory or the dental surgery in a parcel, for example with a parcel service. To this end, a certain infrastructure has to be created, such as, for example, a computer with a remote transmission connection as well as means that can handle the dispatch of relatively large amounts of manufactured dental prostheses as automated as possible.

Dentistry laboratories and dental surgeries furthermore sometimes need material that is normally supplied by wholesalers.

### SUMMARY OF THE INVENTION

It is the object of the present invention to provide methods, a machine-readable data carrier as well as a computer for a more efficient utilization of the infrastructure for the supply of dental surgeries or dentistry laboratories.

This object is achieved with the method according to claims 1, 6, 8 and 10, the machine-readable data carrier according to claim 12, and the computer and/or system according to claim 14. Preferred embodiments are disclosed in the depending claims.

In one method, the data records, such as a model data record for a dental prosthesis as well as a data record for ordering products, such as dentistry laboratory or dental surgery accessories, are created on one and the same computer. The two data records can be transmitted via the remote data transmission means provided for the computer. It is preferred to transmit the two data records together. However, they can also be sent successively or to different points independent of one another. However, preferably the same remote data transmission means of the one computer is always used.

The remote data transmission means can comprise or be, for example, an Internet connection.

Particularly advantageous is a method in which the data record for the manufacture of a dental prosthesis or, during the creation of the first data record, respectively, information for the creation of the second data record are gathered or generated. Thus, certain dental prostheses can require, for example, a certain cement or adhesive, in particular in a case where particular adhesion problems or stability problems have to be expected with the dental prosthesis, so that certain special cements or special adhesives should be employed. The information about such required or recommended substances, such as adhesives, cements or similar accessories, can be acquired by means of the information of the first data record or the step of creating the first data record and correspondingly processed for a second data record.

During the creation of a model data record for the manufacture of a dental prosthesis, for example the volume or area for which cement or adhesive is required can also be determined. Correspondingly, a required amount of adhesive or cement can be calculated, and these information can be worked into the second data record, so that then, for example, a corresponding amount of adhesive or cement is portioned or an appropriate pre-portioned amount is selected and sent to the dentistry laboratory or the dental surgery. To this end, one can, for example, access the data of the first data record when the data of the second data record are created.

The data of the first record and the data of the second record are preferably created not only on one and the same computer, but also with one and the same software. This facilitates a possible overlapping of the software components for the creation of the two data records and also permits a corresponding efficient utilization of the computer resources.

When the second data record is created, an electronic product catalogue is preferably used. The product catalogue can be stored on the computer on which the two data records are created. However, it can also be stored at another location, so that one can access the product catalogue via remote data transmission. This permits central creation and updating of a corresponding product catalogue. The catalogue can comprise more than ten, hundred, thousand, ten thousands or a hundred thousands products.

Another method relates to the reception of data records and their corresponding processing. The method comprises the step of receiving a first data record from a user, the data record being transmitted via remote data transmission and being required for the manufacture of dental prostheses. This data record or a part thereof or a data record acquired therefrom can be forwarded to a dental prosthesis manufacturing system. Furthermore, a second data record of the user is received, this second data record concerning the dispatch of products, such as accessories for a dentistry laboratory or a dental surgery. A corresponding data record is forwarded to a product dispatch system. The two data records can be transmitted as a unit and be divided into the two data records only after this unit has been received. The two data records can, however, also have been transmitted separately by the same user and correspondingly received separately.

The second data record or data acquired from it can be forwarded to the product dispatch system by means of remote data transmission, the data then being transmitted, as a rule, to an external company. However, the forwarding can also be effected locally, such as in a local network, within a company if the product dispatch system is operated by the same company as the dental prosthesis manufacturing system.

Furthermore, the invention relates to a method wherein two data records of one and the same user are received, wherein one data record concerns the manufacture of dental prostheses and the other one concerns the dispatch of products. Both data records are received in a dental prosthesis manufacturing center. Furthermore, the dental prosthesis is manufactured and the dental prosthesis is dispatched together with the one or several products. As dental prostheses are anyway correspondingly dispatched by a dental prosthesis manufacturing center, at the same time, however, have a virtually negligible weight, a corresponding dispatch can be additionally used for the dispatch of further products, such as dentistry laboratory or dental surgery accessories. The infrastructure required for the dispatch of such dental prostheses can be used more efficiently in this manner. This is in particular true if in a dental prosthesis manufacturing center, for example, several hundreds, thousands or ten thousands of dental prostheses are manufactured and dispatched on one single day.

The product data given in the second data record can be transmitted by the dental prosthesis manufacturing center to another location via remote data transmission, and corresponding products can be dispatched from there to the dental prosthesis manufacturing center. In this case, the dental prosthesis manufacturing center can have a delivery of a relatively high number of products from several second data records at a time, so that this, too, results in an efficient use of resources.

Furthermore, the invention relates to a method, wherein a dental prosthesis is manufactured, one or several products are provided and the dental prosthesis and the one or several products are packed into a common parcel and this one parcel is then dispatched. For the above-mentioned reasons, this results in an efficient use of the infrastructure for the dispatch of dental prostheses.

The invention further relates to a machine-readable data carrier with instructions for carrying out one of the above-mentioned methods with a computer.

The machine-readable data carrier can comprise instructions for a first module for acquiring data for the manufacture of a dental prosthesis and concern instructions for a second module for acquiring data concerning the dispatch of products. The two modules are corresponding software modules which are preferably modules of the same software.

Furthermore, the invention relates to a computer which is designed for carrying out one of the methods mentioned above or below. The invention also relates to a system which can be, for example, provided with such a computer and which furthermore comprises e.g. a dental prosthesis manufacturing system and/or a dental prosthesis packing system and/or a dental prosthesis storage system and/or a product storage system and/or a product packing system and/or a system providing packages for collection. The product storage system with the product packing system and the system providing packages for collection is a product dispatch system. This system can also be provided for also storing, packing or dispatching one or several dental prostheses.

### BRIEF DESCRIPTION OF THE DRAWINGS

Preferred embodiments of the invention are to be illustrated with reference to the enclosed figures. In the drawings:

FIG. 1 shows a device for creating data records, and

FIGS. 2 to 5 show schematic representations of processes in carrying out embodiments of the invention.

### DETAILED DESCRIPTION OF THE INVENTION

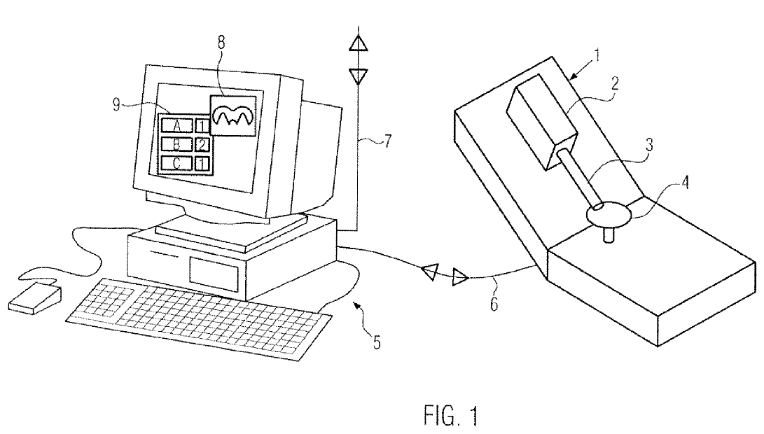

In FIG. 1, a device 1 for scanning tooth models or models of remaining tooth areas is schematically shown. Such devices are well-known. A model can be, for example, arranged on a rotary table 4 and be scanned by an optical scanner 2 with a light beam or a luminous beam 3.

Such a scanner 1 is connected to a computer 5 via a local data transmission connection 6. The computer 5 controls the scanner 1 and stores the data acquired during scanning. With the data that have been acquired during scanning, a model for a dental prosthesis can be created on the computer 5. This can be made automatically or with the assistance of a user. A corresponding model for a dental prosthesis is schematically shown in the window 8 in FIG. 1.

In another window 9 in the computer in FIG. 1, an order list for various products A, B, C is schematically shown. One unit of product A, two units of product B and one unit of product C are to be ordered. It is also possible that only one product each or two, four, five or more different products are ordered.

A product catalogue from which the products can be e.g. selected is stored on computer 5 (or accessible via a local network). However, the product catalogue can also be stored at the dental prosthesis manufacturing center 14 or the location 26 and be made accessible via Internet.

The data record concerning the dental prosthesis represented in window 8 as well as a data record of the order of window 9 can be transmitted via the common remote data transmission line 7. This can be, for example, an Internet connection. Although in FIG. 1 a line is represented, the connection can also be wireless (via radio).

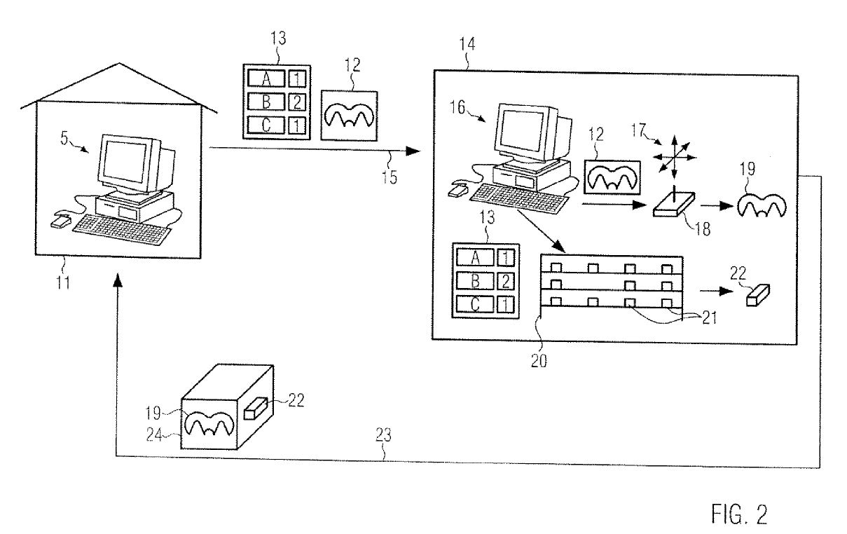

FIG. 2 shows how a computer 5 is arranged in a dental surgery 11 or a dentistry laboratory 11. A data record 12 representing the model of a dental prosthesis as well as an order list 13 are symbolically represented. These are transmitted via remote data transmission 15 to a dental prosthesis manufacturing center 14. There, a computer 16 for receiving the data transmitted via the remote data transmission 15 is provided. The computer 16 forwards data concerning the manufacture of a dental prosthesis to a dental prosthesis manufacturing system 17. This is here symbolically represented by a triaxial milling machine. However, it can also be any other arbitrary manufacturing system for dental prostheses. Here, in particular a litographic 3D laser system, a milling machine with more than three axes or any other rapid prototyping system are possible. With the milling machine 17 which is symbolically shown in FIG. 2, a dental prosthesis or else several dental prostheses can be obtained from a blank 18. Such a dental prosthesis is shown in FIG. 2 at reference numeral 19. Such a dental prosthesis 19 can be stored in a (non-depicted) dental prosthesis storage system until it is packed and/or dispatched.

Furthermore, a data record 13 concerning the order is forwarded to a product storage system 20 or a product dispatch system 20, respectively, which is schematically shown as high-rise warehouse in FIG. 2. There, products 21 are provided, wherein in FIG. 2 a product 22 taken from the high-rise warehouse 20 is represented. The dental prosthesis 19 and the product 22 can now be dispatched to the dentistry laboratory 11 or the dental surgery 11 in a common parcel 24 by a parcel service 23. For packing the dental prosthesis and/or the product, a (non-depicted) packing system can be provided which is preferably computer-controlled and operates automatically.

The product 22 individually shown in FIG. 2 is here representative of one or several products. This is correspondingly true for the following illustrations.

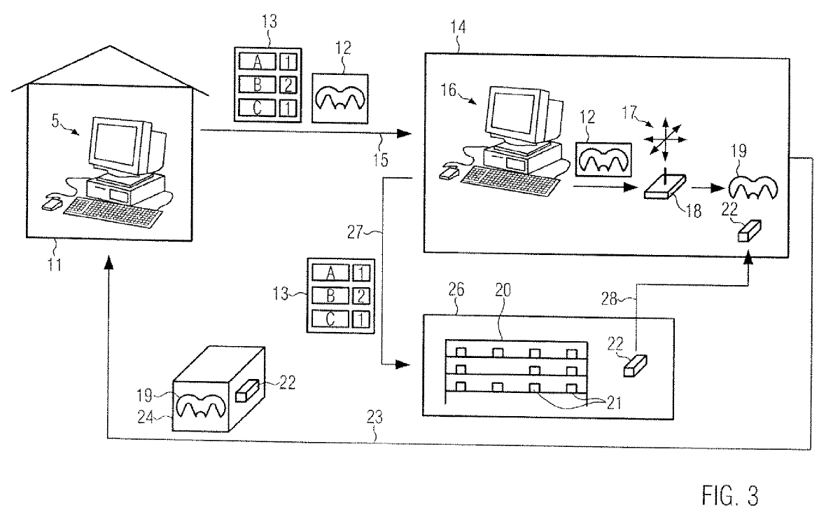

In FIG. 3, a variant of the method of FIG. 2 is represented. Here, the second data record 13 is transmitted to a remote location 26 via remote data transmission 27. This can be, for example, the place of a dental accessories wholesaler or the like. They deliver products 22 to the dental prosthesis manufacturing center 14 via product dispatch, such as by a parcel service 28. In this way, a manufactured dental prosthesis 19 and a product 22 can in turn be dispatched together in a common parcel 24.

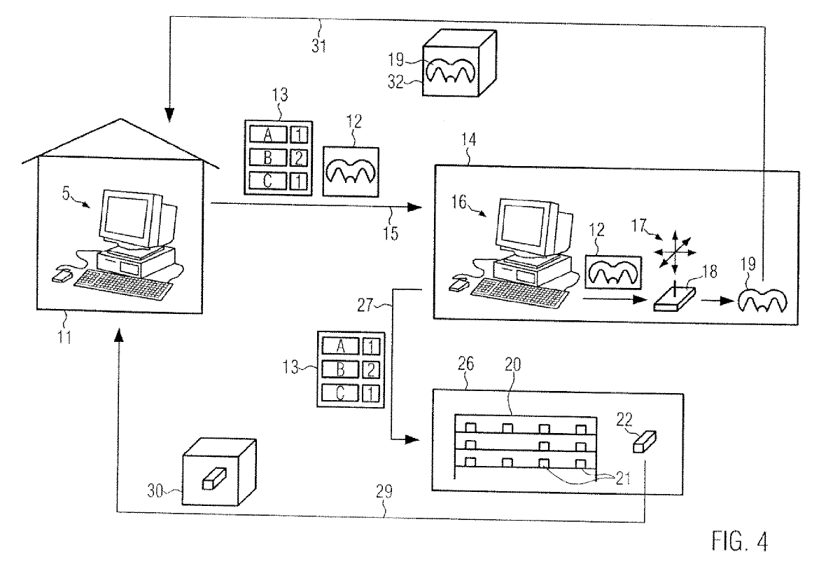

A modification of the method of FIG. 3 is represented in FIG. 4. Here, the product 22 provided by the company at the location 26 is not dispatched to the dental prosthesis manufacturing center 14 but directly in a separate parcel 30 to the dentistry laboratory or the dental surgery 11, respectively. Here, respective separate packing systems for the dental prosthesis and the product are provided.

The method of FIG. 3 and FIG. 4 can also be optionally employed, for example, the method according to FIG. 3 is in particular advantageous for smaller products 22, whereas the method according to FIG. 4 is advantageous for larger and heavier products, respectively. The decision of whether a product 22 is dispatched to the dentistry laboratory or the dental surgery 11 according to the method of FIG. 3 or according to the method of FIG. 4 (corresponding to the two variants of claim 7) can be made by the computer 16 in the manufacturing center 14.

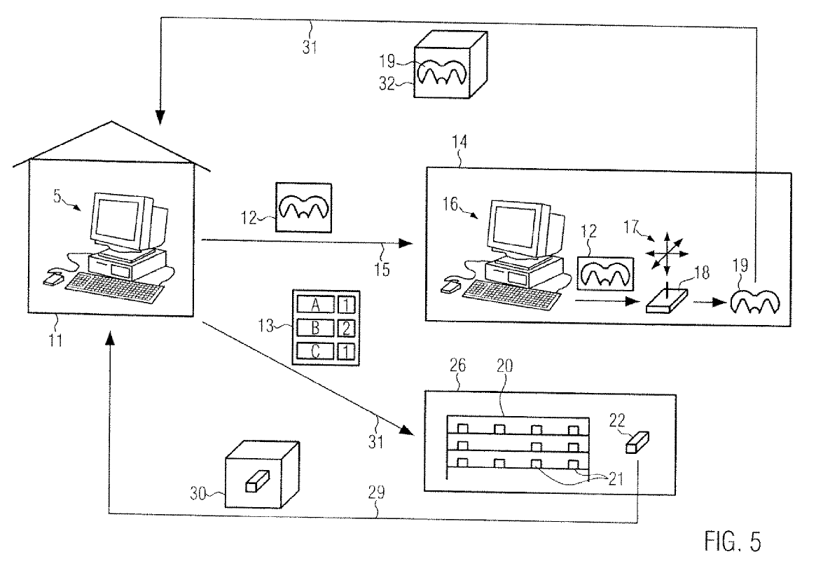

FIG. 5 shows another variant of a method, wherein the data records 12 and 13 are created on the one computer 5 in the dental surgery or in the dentistry laboratory 11, these are, however, then transmitted separately. The data record 12 concerning the manufacture of a dental prosthesis is transmitted to the manufacturing center 14, and the data record 13 concerning an order of products is transmitted to location 26. The separate transmission, however, is preferably not visible for the user of the computer 5 but is preferably rather carried out by one and the same software.

In FIG. 5 it is represented that a product 22 is returned in a parcel 30 and the dental prosthesis 19 in another parcel 32.

Here, however, it is also possible that the dental prosthesis 19 of the manufacturing center 14 is dispatched to the location 26, so that the dental prosthesis 19 is sent along in the parcel 30, or it is vice-versa possible that the product 22 (representative of one or several products) is dispatched to the dental prosthesis manufacturing center 14 and dispatched together with the dental prosthesis 19 in the parcel 32. Then, the parcel 30 is eliminated.

In a case where the second data record is not directly dispatched to the dental prosthesis manufacturing center 14, it is furthermore advantageous if a corresponding data record or a part thereof or a data record acquired therefrom is transmitted from the location 26 to the dental prosthesis manufacturing center 14. This then for example permits uniform billing for the dental prosthesis 19 and the product 22 by the dental prosthesis manufacturing center 14.

1. Method with the steps of:
creating a first data record (12) required for the manufacture of a dental prosthesis (19), with a computer (5);
transmitting the first data record (12) to a manufacturing center (14) for dental prostheses (19) by means of remote data transmission (15) by the computer (5),
characterized by
the steps of:
creating a second data record (13) concerning the dispatch of products (22), such as accessories for a dentistry laboratory or a dental surgery, such as, for example, accessories for fitting dental prostheses, with the computer, and
dispatching the second data record (13) to the manufacturing center (14), preferably together with the first data record (12), or to a location (26) other than the manufacturing center (14) via remote data transmission (15).

2. Method according to claim 1, characterized in that in the step of creating the first data record (12) information for the creation of the second data record (13) are gathered and/or generated, such as information on required or possible substances for the use of the dental prosthesis (19) belonging to the first data record (12).

3. Method according to claim 1, characterized in that in the step of creating the second data record (13) data of the first data record (12) are consulted.

4. Method according to claim 1, characterized in that the two data records (12, 13) are created with one and the same software (8, 9).

5. Method according to claim 1, characterized in that in the creation of the second data record (13), an electronic product catalogue is used, this product catalogue being accessed, for example, via remote data transmission, and this product catalogue being stored at the manufacturing center for dental prostheses or at another location.

6. Method with the steps of:
receiving a first data record (12) of a user (11) required for the manufacture of dental prostheses (19), and
forwarding the data record (12) or at least a part thereof or a data record acquired therefrom to a dental prosthesis manufacturing system (17);
receiving a second data record (13) of a user, the second data record (13) concerning the dispatch of products (22), such as accessories for a dentistry laboratory or a dental surgery, such as, for example, accessories for fixing dental prostheses, and
forwarding the second data record (13) or at least a part thereof or a data record acquired therefrom to a product storage system (22) and/or a product dispatch system (22).

7. Method according to claim 6, characterized in that the forwarding to the product storage system (22) and/or the product dispatch system (22) is effected by means of remote data transmission (27) or with local data transmission means, such as a local network.

8. Method with the steps of:
receiving:
a first data record (12) of a user (11) required for the manufacture of dental prostheses (19), and
a second data record (13) of the same user concerning the dispatch of one or several products (22), such as dental accessories, in a dental prosthesis manufacturing center (14)
manufacturing the dental prosthesis (19), and
dispatching (23) the dental prosthesis (19) together with the one or several products (22).

9. Method according to claim 8, characterized in that information concerning the dispatch of products (22), such as dental accessories, are transmitted according to the second data record (13) via remote data transmission (27) to another location (26), such as that of a dental accessories supplier, and corresponding dental accessories (22) are dispatched (28) from the other location (26) to the dental prosthesis manufacturing center (14).

10. Method with the steps of:
manufacturing a dental prosthesis (19);
providing one or several products (22), such as accessories for a dentistry laboratory, for example accessories for fixing dental prostheses, and
packing the dental prosthesis (19) and the one or several products (22) into a common parcel (24).

11. Method according to claim 10, characterized by the dispatch of the parcel (30).

12. Machine-readable data carrier with instructions that can be carried out by a computer (5, 16), so that a method according to claim 1 is carried out.

13. Machine-readable data carrier according to claim 12, characterized in that instructions for a first module (8) for acquiring data for the manufacture of a dental prosthesis, and instructions for a second module (9) for acquiring data concerning the dispatch of products, such as dental accessories, such as accessories for fixing dental prostheses, are provided.

14. Computer and/or system designed for carrying out one of the methods according to claim 1.
